(19) United States
(12) Patent Application Publication
(10) Pub. No.: US 2006/0016321 A1
(43) Pub. Date: Jan. 26, 2006

(54) Apparatus and method for controlling sounds and images

(75) Inventors: Kuan-Hong Hsieh, Tu-Cheng (TW); Xiao-Guang Li, Shenzhen (CN); Xin Lu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/141,095

(22) Filed: May 31, 2005

(30) Foreign Application Priority Data
Jul. 23, 2004 (TW) 93122049

(51) Int. Cl. G10H 7/00

(52) U.S. Cl. 84/602

(57) ABSTRACT

An apparatus for controlling sounds and images includes: a first memory (11) for storing songs and MMHL (Multi Media Hyper Link) files, each MMHL file including timeline information, lyrics, pictures and videos of a corresponding song, the timeline information including a plurality of time slices and related actions of each time slice; a second memory (13) for storing read songs and MMHL fifes matched with the songs; a third memory (12) for storing one or more controlling programs; and a Central Processing Unit (CPU) (10) for reading a song, obtaining an MMHL file matched with the song, and controlling simultaneous output of the song and the MMHL file according to the timeline information, via the controlling programs. A related method is also disclosed.

### BACKGROUND OF THE INVENTION

1. Field of the Invention

The present invention relates generally to apparatuses and methods for controlling sounds and images, and particularly to an apparatus and method for simultaneously playing songs and multimedia information.

2. General Background

Conventionally, a device capable of playing MPEG layer 3 (MP3) songs converts song files into audio files, and then converts the audio files into digital sounds for outputting the songs.

In general, such device can only output digital sounds, and cannot display lyrics corresponding to the songs. The device can compress sound files, but cannot compress image files. Accordingly, a more sophisticated playing apparatus has been developed. The playing apparatus can output digital sounds, and digital images such as lyrics. In the playing apparatus, a Central Processing Unit (CPU) controls an audio output unit to output decompressed digital sounds. At the same time, the CPU searches for lyrics matched with the songs in the memory, processes the lyrics, and outputs digital images. Thus the songs and the corresponding lyrics are output simultaneously.

However, the playing apparatus cannot dynamically display image files. In addition, with the ongoing development of multimedia technology, there has been a growing demand for simultaneous outputting of songs, pictures and photographs.

What is needed is an apparatus and method for simultaneously playing sounds and images which can overcome the above-described problems, in order to provide a user with more information and enjoyment.

### SUMMARY

An apparatus for controlling sounds and images in accordance with a preferred embodiment includes a control unit, an audio output unit for outputting digital sounds of a song, and a video output unit for outputting digital multimedia information of a Multi Media Hyper Link (MMHL) file matched with the song. The control unit includes: a first memory for storing songs and MMHL files, each MMHL file including timeline information, lyrics, pictures and videos of a corresponding song, the timeline information including a plurality of time slices and related actions of each time slice, as the related action including any one or more of loading a text file, loading an image file, loading a user setting, and loading other MMHL files; a second memory for temporarily storing read songs and MMHL files matched with the songs; a third memory for storing one or more controlling programs; and a Central Processing Unit (CPU) for reading a song, obtaining an MMHL file matched with the song, and controlling simultaneous output of the song and the MMHL file according to the timeline information, via the controlling programs.

A method for controlling sounds and images is also provided. The method includes the steps of: (a) providing a first memory for storing songs and MMHL files matched with the songs; (b) reading an song; (c) obtaining MMHL file information matched with the song according to a name of song, the MMHL file information comprising timeline information, the timeline information including a plurality of time slices and related actions of each time slice; and (d) outputting digital sounds of the song and digital multimedia information of the MMHL file.

Other advantages and novel features will be drawn from the following detailed description of the embodiments with reference to the attached drawings, in which:

### BRIEF DESCRIPTION OF THE DRAWINGS

FIG. 1 is a schematic diagram of hardware infrastructure of an apparatus for controlling sounds and images in accordance with a preferred embodiment of the present invention;

FIG. 2 is a tree diagram illustrating information of an MMHL file stored in a memory of the apparatus of FIG. 1;

FIG. 3 is a tree diagram illustrating related actions of a time slice of the information shown in FIG. 2; and

FIG. 4 is a flowchart of a preferred method for implementing the apparatus of FIG. 1.

### DETAILED DESCRIPTION OF THE EMBODIMENTS

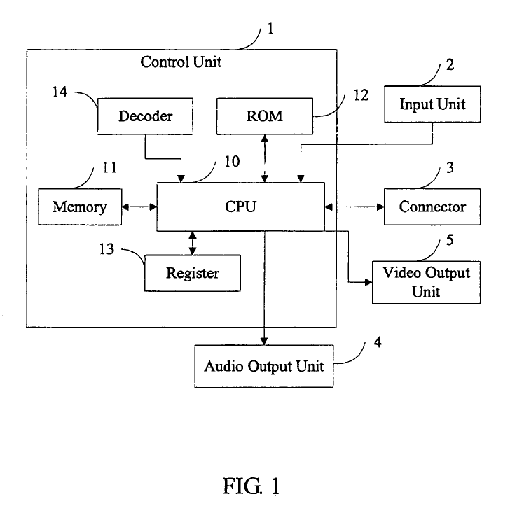

Referring now to the drawings, FIG. 1 is a schematic diagram of hardware infrastructure of an apparatus for controlling sounds and images (hereafter, “the apparatus”) in accordance with a preferred embodiment of the present invention. In this embodiment, the apparatus includes a control unit 1, an input unit 2, a connector 3, an audio output unit 4, and a video output unit 5.

The control unit 1 is provided for controlling simultaneous output of songs and multimedia files or Multi Media Hyper Link (MMHL) files. The control unit 1 includes a Central Processing Unit (CPU) 10, a memory 11, a Read Only Memory (ROM) 12, a register 13, and a decoder 14.

The CPU 10 is respectively connected with the memory 11, the ROM 12, the register 13, and the decoder 14. The CPU 10 searches a multimedia file or an MMHL file corresponding to a song, and controls simultaneous output of the song and the corresponding multimedia file or MMHL file.

The memory 11 stores a plurality of songs, multimedia files and MMHL files. The songs, multimedia files, and MMHL files may be either in an uncompressed format or in a compressed format. With respect to the compressed format, the songs may be in an MPEG audio layer 3 (MP3) format, an Advanced Audio Coding (AAC) format, or any other suitable format. The multimedia files may be in a text (TXT) format, a Joint Photographic Experts Group (JPG/JPEG) format, a Graphics Interchange Format (GIF), or a Motion Picture Experts Group (MPEG) format. The MMHL files may be in an Extensible Markup Language (XML) format. Further, the multimedia files include various contents, such as lyrics, pictures, videos, and so on. The MMHL files include various contents which match with the songs, such as timeline information, lyrics, pictures, videos, and so on. Similar to the multimedia files, an XML file may be in a TXT format, a JPG/JPEG format, a GIF format, or an MPEG format. In the preferred embodiment, each song has a designated name format. That is, the name of each song includes 6 parts: a file name of the song, a first designated symbol, a file name of a multimedia file or an MMHL file corresponding to the song, a second designated symbol, an extension of the corresponding multimedia file or MMHL file, and an extension of the song. The first and second designated symbols may each be a character which can be recognized by the control unit 1. For example, the first and second designated symbols may both be a question mask “?.” Thus, when a song with the name, for example, “XXX?YYY?XML.MP3” is to be played, the CPU 10 extracts the file name and the extension of the MMHL file, namely “YYY.XML,” from the name of the song, and then searches for the MMHL file from the memory 11.

The ROM 12 stores controlling programs for implementing the present embodiment.

The register 13 stores songs which have been read out, and respective multimedia files or MMHL files corresponding to the songs.

The decoder 14 is operable for decompressing the songs, and the corresponding multimedia files or MMHL files, in the register 13.

The input unit 2 is programmed to receive a user operation selecting a song to be played. The connector 3 is used for connecting the control unit 1 with the electronic device (not shown), in order to download songs, multimedia files and MMHL files from the electronic device. The audio output unit 4 is provided for playing digital sounds of the songs. The video output unit 5 is used for playing digital multimedia information of the multimedia files or the MMHL files.

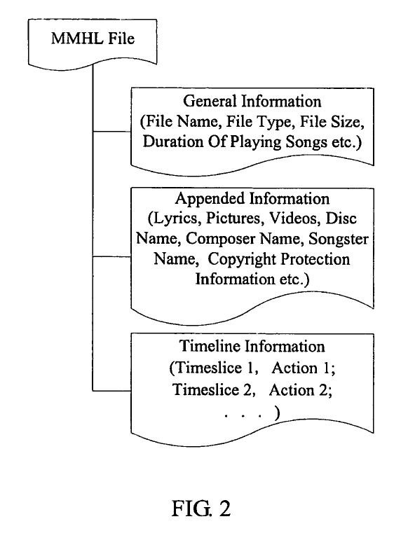

FIG. 2 is a tree diagram illustrating information of an MMHL file. The information of the MMHL file includes general information, appended information and timeline information. The general information includes a name, a type, and a size of the MMHL file, and a duration of playing the corresponding song. The appended information includes various related contents corresponding to the song, such as lyrics, pictures, videos, a disc name, a composer name, a songster name, and copyright protection information. The timeline information includes a plurality of time slices and related actions thereof.

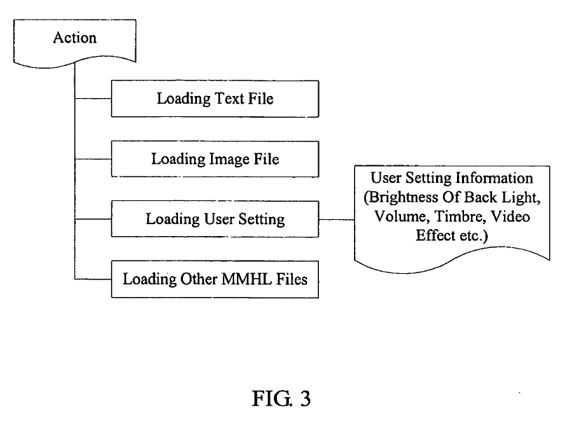

FIG. 3 is a tree diagram illustrating related actions of a time slice in the MMHL file. The related actions include loading a text file, loading an image file, loading a user setting, and loading other MMHL files. The user setting includes a brightness of a back light, a volume, a timbre, a visible video effect, etc. The action of loading other MMHL files means inserting another song and a corresponding MMHL file thereof before a selected song.

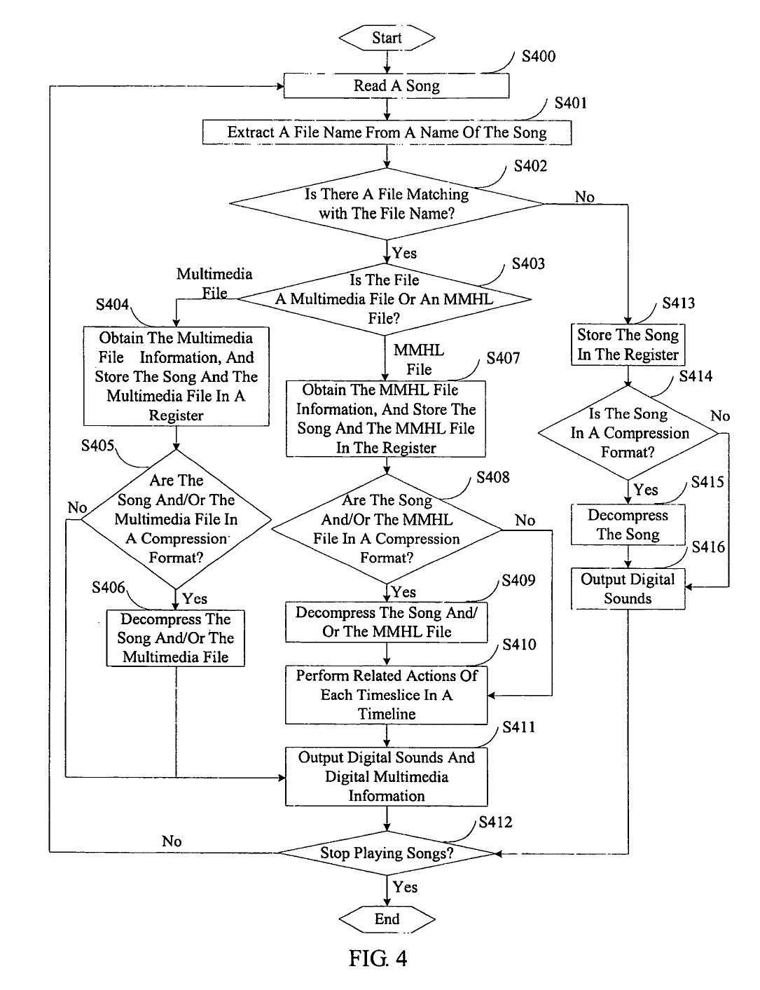

FIG. 4 is a flowchart of a preferred method for implementing the present invention by utilizing the above-described apparatus. In step S400, the CPU 10 reads a song from the memory 11. In step S401, the CPU 10 extracts a file name from a name of the song. In step S402, the CPU 10 searches the memory 11 for a file which matches with the file name. If there is no matching file in the memory 11, the procedure goes to step S413 described below. If there is a matching file in the memory 11, in step S403, the CPU 10 determines whether the file is a multimedia file or an MMHL file. If the file is an MMHL file, the procedure goes to step S407 described below. If the file is a multimedia file, in step S404, the CPU 10 obtains information of the multimedia file from the memory 11, and stores the song and the multimedia file in the register 13. Then in step S405, the CPU 10 determines whether the song and/or the multimedia file are/is in a compressed format. If the song and/or the multimedia file are/is in a compressed format, in step S406, the decoder 14 decompresses the song and/or the multimedia file, whereupon the procedure goes to step S411 described below. Otherwise, if neither the song nor the multimedia file is in a compressed format, the procedure goes directly to step S411 described below.

In step S407, the CPU 10 obtains information of the MMHL file, and stores the song and the MMHL file in the register 13. Then in step S408, the CPU 10 determines whether the song and/or the MMHL file are/is in a compressed format. If neither the song nor the MMHL file is in a compressed format, the procedure goes directly to step S410 described below. Otherwise, if the song and/or the MMHL file are/is in a compressed format, in step S409, the decoder 14 decompresses the song file and/or the MMHL file, whereupon the procedure goes to step S410. In step S410, the CPU 10 performs related actions of each time slice in the timeline. In step S411, the audio output unit 4 outputs digital sounds of the song. At the same time, the video output unit 5 outputs digital multimedia information of the MMHL file according to the timeline information of the song. The procedure then goes to step S412 described below.

In step S413, the CPU 10 stores the song in the register 13. Then in step S414, the CPU 10 determines whether the song is in a compressed format. If the song is not in a compressed format, the procedure goes directly to step S416 described below. Otherwise, if the song is in a compressed format, in step S415, the CPU 1 decompresses the song, whereupon the procedure goes to step S416. In step S416, the audio output unit 4 outputs the digital sounds of the song, whereupon the procedure goes to step S412.

In step S412, the CPU 10 determines whether to stop playing songs. If the CPU 10 determines to continue playing songs, the procedure returns to step S400 described above. In contrast, if the CPU 10 determines to stop playing songs, the procedure is finished.

Although the present invention has been specifically described on the basis of a preferred embodiment and preferred method, the invention is not to be construed as being limited thereto. Various changes or modifications may be made to the embodiment and method without departing from the scope and spirit of the invention.

We claim:

1. An apparatus for controlling sounds and images, the apparatus comprising a control unit, an audio output unit for outputting digital sounds of a song, and a video output unit for outputting digital multimedia information of a Multi Media Hyper Link (MMHL) file matched with the song, wherein the control unit comprises:
a first memory for storing songs and MMHL files, each MMHL file comprising timeline information of a song, the timeline information comprising a plurality of time slices and related actions of each time slice;
a second memory for storing read songs and MMHL files matched with the songs;
a third memory for storing one or more controlling programs; and
a Central Processing Unit (CPU) for reading a song, obtaining an MMHL file matched with the song, and controlling simultaneous output of the song and the MMHL file according to the timeline information, via the controlling programs.

2. The apparatus described as in claim 1, further comprising an input unit connected with the CPU, for receiving a user operation selecting a song.

3. The apparatus described as in claim 1, wherein the control unit further comprises a decoder connected with the CPU, for decompressing the song and/or the MMHL file if the song and/or the MMHL file is in a compressed format.

4. The apparatus described as in claim 1, wherein a name of each song includes 6 parts: a file name of the song, a first designated symbol, a file name of a multimedia file or an MMHL file corresponding to the song, a second designated symbol, an extension of the corresponding multimedia file or MMHL file, and an extension of the song, the first and second designated symbols each being a character which can be recognized by the control unit.

5. The apparatus described as in claim 1, wherein the MMHL file further comprises lyrics, pictures and videos of the corresponding song.

6. The apparatus described as in claim 1, wherein the related actions comprise any one or more of loading a text file, loading an image file, loading a user set, and loading other MMHL files.

7. The apparatus described as in claim 1, wherein the MMHL file is in an Extensible Markup Language (XML) format.

8. The apparatus described as in claim 7, wherein the XML file is in a text (TXT) format, a Joint Photographic Experts Group (JPG/JPEG) Format, a Graphics Interchange Format (GIF), or a Motion Picture Experts Group (MPEG) format.

9. A method for controlling sounds and images, the method comprising the steps of:
providing a first memory for storing songs and Multi Media Hyper Link (MMHL) files matched with the songs;
reading a song;
obtaining MMHL file information matched with the song based on a name of the song, the MMHL file information comprising timeline information, the timeline information comprising a plurality of time slices and related actions of each time slice; and
outputting digital sounds of the song and digital multimedia information of the MMHL file.

10. The method described as in claim 9, further comprising the step of loading the song and the MMHL file matched with the song to a second memory.

11. The method described as in claim 9, further comprising the step of decompressing the song and/or the MMHL file, if the song and/or the MMHL file is in a compressed format.

12. The method described as in claim 9, wherein the related actions comprise any one or more of loading a text file, loading an image file, loading a user set, and loading other MMHL files.

13. A method for displaying image information of a song together with playing of said song, the method comprising the steps of:
retrieving a file name of said song designating to an audio file recording said song;
retrieving said image information by means of searching image files related to said image information based on said file name of said song; and
playing said song from said audio file and displaying said image information from said image files simultaneously.

14. The method described as in claim 13, wherein said image files are in one of a multimedia format and a multi media hyper link (MMHL) format.
